(19) United States
(12) Patent Application Publication
(10) Pub. No.: US 2019/0122607 A1
(43) Pub. Date: Apr. 25, 2019

(54) AUTOMATIC ADJUSTING METHOD OF LUMINANCE AND BRIGHTNESS FOR AMOLED DISPLAY DEVICE

(71) Applicant: WUHAN CHINA STAR OPTOELECTRONICS SEMICONDUCTOR DISPLAY TECHNOLOGIES CO., LTD., Wuhan, Hubei (CN)

(72) Inventor: Weinan YAN, Wuhan, Hubei (CN)

(21) Appl. No.: 15/735,611

(22) PCT Filed: Dec. 7, 2017
(86) PCT No.: PCT/CN2017/114894

§ 371 Date: Dec. 12, 2017

(30) Foreign Application Priority Data
Oct. 25, 2017 (CN) 201711009422.5

(51) Int. Cl. G09G 3/3225; G09G 3/20

(52) U.S. Cl. CPC G09G 3/3225; G09G 3/2003; G09G 2320/0653; G09G 2320/0233; G09G 2360/145; G09G 3/2007

(57) ABSTRACT

The present disclosure provides an automatic adjusting method of luminance and brightness for an AMOLED display device including an optical measuring module measures luminances and chromaticity coordinates of a display module and transmits the measured result to an operation control module. The operation control module is configured to obtain target luminances and chromaticity coordinates of grayscales by calculating the target luminances and gamma curves, and configured to calculate driving voltages for making luminances and chromaticity coordinates of the display module close to a target. The operation control module transmits the required driving voltages to the display device.

### FIELD OF INVENTION

The present disclosure relates to the field of display technology, and more particularly to an automatic adjusting method of luminance and brightness for an active matrix organic light emitting diode (AMOLED) display device.

### BACKGROUND OF INVENTION

Active matrix organic light emitting diode (AMOLED) display technologies, which are used in televisions and portable devices, have advantages, such as a high contrast, wide viewing angles, low power-consumption, and thin volume in comparison with present liquid crystal display devices. Therefore, AMOLED may become the next generation display technology, and has become one of the most attractive display technologies. Display performance may be different due to process techniques used during manufacturing. Color temperatures and gamma parameters may also differ from each user requirement. Therefore, adjusting brightness and luminance before leaving the factory is required for making consistent batch of products. Adjusting brightness and luminance for AMOLEDs is difficult due to their emitting mechanism and characteristics. In addition, the reaction is slower. Therefore, manufacturing capacity is affected.

To conclude, present adjusting methods of brightness and luminance for AMOLEDs are difficult and affected by variable factors of manufacturing due to the emitting mechanism and characteristics of AMOLEDs. In addition, the reaction is slower. Therefore, the manufacturing capacity is affected.

### SUMMARY OF INVENTION

The object of this disclosure is to provide an automatic adjusting method of luminance and brightness for an active matrix organic light emitting diode (AMOLED) display device, so that the automatic adjusting speed of luminance and brightness for AMOLED display devices can be accelerated. In addition, the influence resulting from various factors of manufacture may be reduced. Therefore, the manufacturing capacity of OLED display devices can increase because time spent on adjusting and testing decreases.

To solve the above-mentioned technical problems, the techniques that the present disclosure provides are as follows.

The present disclosure provides an automatic adjusting method of luminance and brightness for an active matrix organic light emitting diode (AMOLED) display device comprising:
step S101: measuring, with an optical measuring module, a maximum luminance LRm of a red image, a maximum luminance LGm of a green image, and a maximum luminance LBm of a blue image displayed by the display module, and obtaining chromaticity coordinate corresponding to the maximum luminance LRm, maximum luminance LGm, and maximum luminance LBm; step S102: transmitting the maximum luminance LRm, maximum luminance LGm, maximum luminance LBm, and the chromaticity coordinate corresponding to the maximum luminance LRm, maximum luminance LGm, and maximum luminance LBm from the optical measuring module to an operation control module;
step S103: calculating, with the operation control module, target luminances of grayscales according to the maximum luminance LRm, maximum luminance LGm, maximum luminance LBm, and a gamma curve, adjusting driving voltages corresponding to target chromaticity coordinate, and calculating target driving voltages for making luminance of the display module comply with the target luminances of the grayscales, where the operation control module controls the grayscales of the display module, and outputs register values corresponding to the target driving voltages, wherein the target chromaticity coordinate are the chromaticity coordinate corresponding to the maximum luminance LRm, maximum luminance LGm, and maximum luminance LBm;
step S104: controlling, with the operation control module, a display driving module to transmit the target driving voltages to the display module for automatically adjusting current driving voltages.

According to a preferable embodiment of present disclosure, the step S103 comprises following steps:
step S1031: obtaining chromaticity driving voltages making the display modules comply with the target chromaticity coordinate;
step S1032: making the display module illuminate white light by utilizing the chromaticity driving voltages;
step S1033: referencing a minimum luminance to obtain a first luminance corresponding to a group of driving voltages VRi, RGi, and VBi;
step S1034, calculating a second luminance of one of the grayscale corresponding to the maximum luminance LRm, maximum luminance LGm, maximum luminance LBm, and a gamma curve;
step S1035, obtaining the target driving voltages by calculating a interpolation of the first luminance and the second luminance, wherein the target driving voltages comprise VRx, VGx, and VBx corresponding red image, green image, and blue image respectively.

According to a preferable embodiment of present disclosure, the target driving voltages match a formula for making the ratio of VRx, VGx, and VBx remain the same, wherein the formula is:

(V_{R255}−VDD):(V_{G255}−VDD):(V_{B255}−VDD)=(V_{R128}−VDD):(V_{G128}−VDD):(V_{B128}−VDD).

According to a preferable embodiment of present disclosure, the step S104 comprises: outputting the target driving voltages comprising VRx, VGx, and VBx from the display driving module, and fine-tuning the target driving voltages for making the display module comply with the target chromaticity coordinate and the gamma curve.

The present disclosure further provides an automatic adjusting system of luminance and brightness for an active matrix organic light emitting diode (AMOLED) display device comprising:
a display module configured to display;
an optical measuring module configured to optically measure the display module;
an operation control module configured to calculate target luminances and target chromaticity coordinate of grayscales, and calculate target driving voltages making the display module comply with the target luminance and the target chromaticity coordinate;
a display driving module configured to output the target driving voltages to the display module;
wherein the operation control module comprises:
   a calculating unit configured to obtain the target luminances of grayscales according to a maximum luminance of the display module and a gamma curve, and configured to calculate the target driving voltages making luminances of the display module comply with the target luminances; and
   a receiving unit configured to receive luminances and chromaticity coordinate measured by the optical measuring module.

According to a preferable embodiment of present disclosure, the operation control module and the display driving module are configured to adjust white balance when one of the luminances of red, green, or blue measured by the optical measuring module is greater than or equal to the target luminances.

According to a preferable embodiment of present disclosure, the operation control module comprises a storage unit configured to storage a present luminance and luminances regarding the various groups of driving voltages.

According to a preferable embodiment of present disclosure, the operation control module comprises an output control unit configured to control grayscale of the display device, and configured to output a register value corresponding to the target driving voltages.

The present disclosure further provides an automatic adjusting method of luminance and brightness for an active matrix organic light emitting diode (AMOLED) display device comprising:
step S101: measuring, with an optical measuring module, a maximum luminance LRm of a red image, a maximum luminance LGm of a green image, and a maximum luminance LBm of a blue image displayed by the display module, and obtaining chromaticity coordinate corresponding to the maximum luminance LRm, maximum luminance LGm, and maximum luminance LBm;
step S102: transmitting the maximum luminance LRm, maximum luminance LGm, maximum luminance LBm, and the chromaticity coordinate corresponding to the maximum luminance LRm, maximum luminance LGm, and maximum luminance LBm from the optical measuring module to an operation control module;
step S103: calculating, with the operation control module, target luminances of grayscales according to the maximum luminance LRm, maximum luminance LGm, maximum luminance LBm, and a gamma curve, adjusting driving voltages corresponding to target chromaticity coordinate, and calculating target driving voltages for making luminance of the display module complying with the target luminances of the grayscales, wherein the target chromas coordinate are the chromaticity coordinate corresponding to the maximum luminance LRm, maximum luminance LGm, and maximum luminance LBm;
step S104: controlling, with the operation control module, a display driving module to transmit the target driving voltages to the display module for automatically adjusting current driving voltages.

According to a preferable embodiment of present disclosure, the step S103 comprises following steps:
step S1031: obtaining chromaticity driving voltages making the display modules comply with the target chromaticity coordinate;
step S1032: making the display module illuminate white light by utilizing the chromaticity driving voltages;
step S1033: referencing a minimum luminance to obtain a first luminance corresponding to a group of driving voltages VRi, RGi, and VBi;
step S1034, calculating a second luminance of one of the grayscale corresponding to the maximum luminance LRm, maximum luminance LGm, maximum luminance LBm, and a gamma curve;
step S1035, obtaining the target driving voltages by calculating a interpolation of the first luminance and the second luminance, wherein the target driving voltages comprise VRx, VGx, and VBx corresponding red image, green image, and blue image respectively.

According to a preferable embodiment of present disclosure, the target driving voltages matches a formula for making the ratio of VRx, VGx, and VBx remain the same, wherein the formula is:

(V_{R255}−VDD):(V_{G255}−VDD):(V_{B255}−VDD)=(V_{R128}−VDD):(V_{G128}−VDD):(V_{B128}−VDD).

According to a preferable embodiment of present disclosure, the step S104 comprises: outputting the target driving voltages comprising VRx, VGx, and VBx from the display driving module, and fine-tuning the target driving voltages for making the display module comply with the target chromaticity coordinate and the gamma curve.

The benefits of present disclosure are: in comparison with the present adjusting method of luminance and brightness for AMOLED display devices, the present disclosure provides an automatic adjusting method of luminance and brightness for AMOLED display devices which does not require establishing a look up table of single color images regarding driving voltages, thus the influence resulting from various factors of manufacture may be reduced. By utilizing the emitting mechanism and the characteristics of OLEDs, the operations for white balance and adjusting of gamma become more precise and efficient by rapidly approaching the driving voltages to target levels. In the meanwhile, the computing load will decline. Therefore the automatic adjusting speed of luminance and brightness can be accelerated. As a result, the manufacturing capacity of OLED display devise can increase because time spent on adjusting and testing decreases.

### DESCRIPTION OF DRAWINGS

The drawings required for describing the embodiments or present solutions are introduced for the purpose of making the technical solutions in the embodiments of the present invention clear and completely described. Obviously, the described embodiments are only some of the embodiments of the present invention. Other embodiments which can be obtained by a person having ordinary skill in the art without any creative effort on the basis of the embodiments of the present invention shall fall within the scope of the present disclosure.

FIG. 1 illustrates a flowchart of an adjusting method of luminance and brightness for AMOLED display devices of the present disclosure.

FIG. 2 illustrates a flowchart of an adjusting method of luminance and brightness for AMOLED display devices of an operation control module of the present disclosure.

FIG. 3 illustrates the structure of an adjusting system of luminance and brightness for AMOLED display devices of the present disclosure.

FIG. 4 illustrates the structure of an operation control module of the system of the present disclosure.

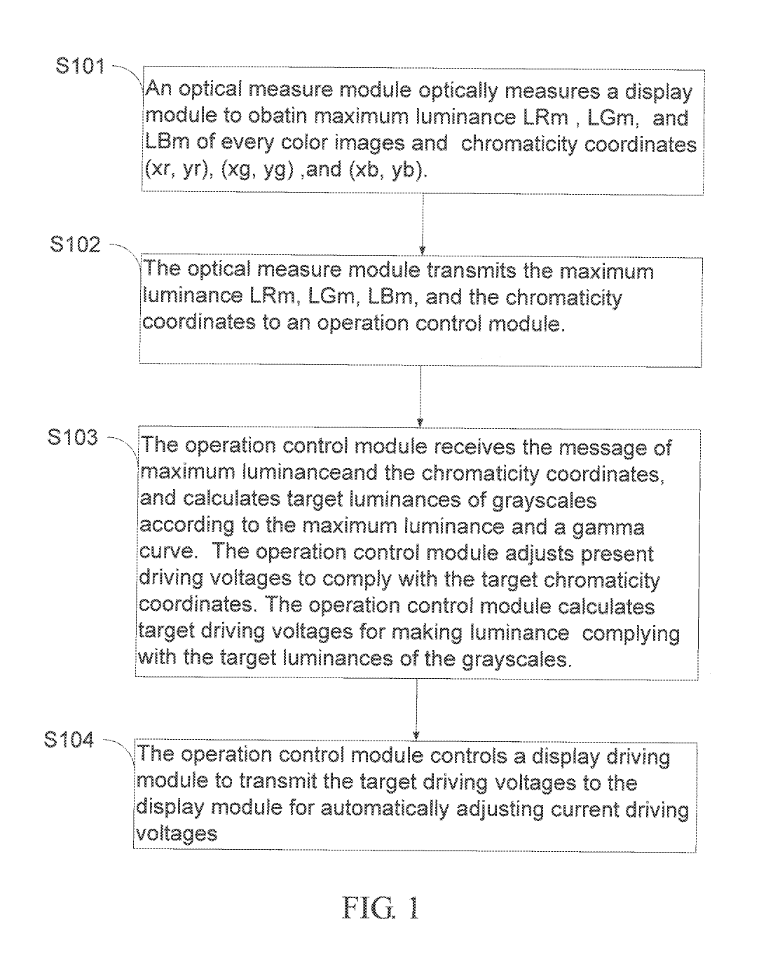

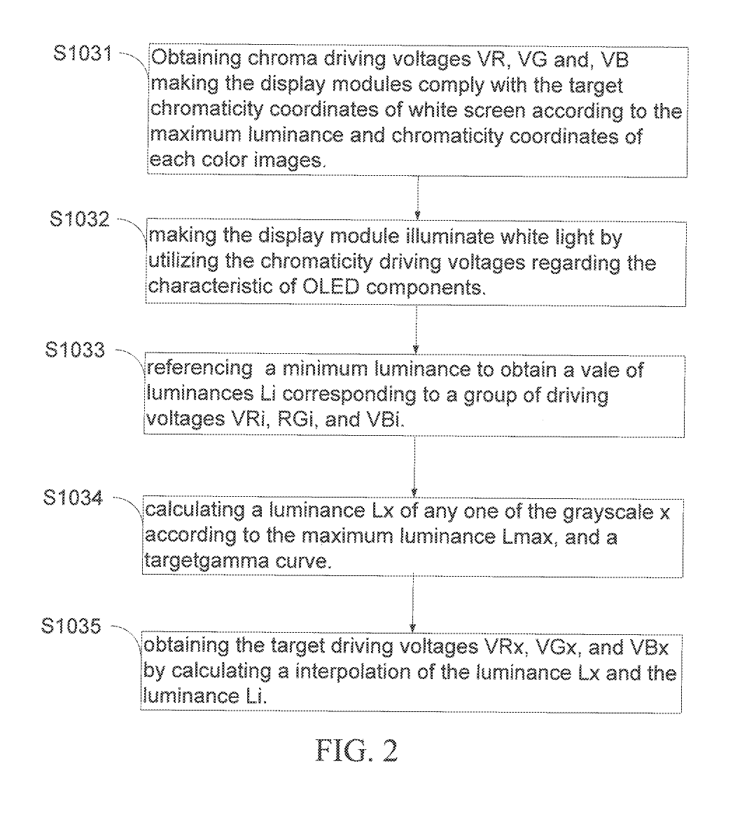

### DETAILED DESCRIPTION OF PREFERRED EMBODIMENTS

The illustrations of the following embodiments take the attached drawings as reference to indicate the applicable specific examples of the present disclosure. The mentioned directional terms, such as upper, lower, front, back, left, right, inner, outer, side, etc., are only directions by referring to the accompanying drawings, and thus the used directional terms are used to describe and understand the present invention, but the present invention is not limited thereto. In the drawings, similar modules are numbered with the same reference numbers.

The present disclosure overcomes the present difficulties, in comparison with liquid crystal displays, of brightness and luminance adjustment for AMOLEDs resulting from the manufacturing diversities regarding the emitting mechanism and characteristics of AMOLEDs, and overcome the problems with manufacturing capacity which is affected by the slow speed.

The present disclosure provides an automatic adjusting method of luminance and brightness for an active matrix organic light emitting diode (AMOLED) display device comprising the following steps.

Step S101: An optical measuring module measures a maximum luminance LRm of a red image, a maximum luminance LGm of a green image, and a maximum luminance LBm of a blue image displayed by the display module, and obtaining chromaticity coordinate (xr, yr), (xg, yg), and (xb, yb) corresponding to the maximum luminance LRm, maximum luminance LGm, and maximum luminance LBm respectively.

Step S102: The optical measuring module transmitting the maximum luminance LRm, LGm, LBm, and the chromaticity coordinate to an operation control module.

Step S103: The operation control module receiving the message of maximum luminance LRm, LGm, LBm, and the chromaticity coordinate, and calculates target luminances of grayscales according to the maximum luminance LRm, maximum luminance LGm, maximum luminance LBm, and a gamma curve; adjusting driving voltages to make the display module comply with the target chromaticity coordinate, where the target chromaticity coordinate is the chromaticity coordinate corresponding to the maximum luminance LRm, maximum luminance LGm, and maximum luminance LBm; calculating target driving voltages for making luminance of the display module comply with the target luminances of the grayscales.

Step S104: the operation control module controlling a display driving module to transmit the target driving voltages to the display module for automatically adjusting current driving voltages.

There is a further step after the step S103: the operation control module controlling the grayscales of the display module that are required, and outputting register values corresponding to the target driving voltages.

The step S103 comprises the following detailed steps.

Step S1031: obtaining chromaticity driving voltages VR, VG, and VB, corresponding to R/G/B respectively, which make the display modules comply with the target chromaticity coordinate for showing a white screen according to the maximum luminance and chromaticity coordinate of each color image.

Step S1032: making the display module illuminate white light by utilizing the chromaticity driving voltages regarding the characteristic of OLED components.

Step S1033: obtaining a value of luminances Li corresponding to a group of driving voltages VRi, RGi, and VBi by referencing a minimum luminance to obtain a value of luminances Li corresponding to a group of driving voltages VRi, RGi, and VBi.

Step S1034, calculating a luminance Lx of any one of the grayscale x according to the maximum luminance Lmax and a target gamma curve.

Step S1035, obtaining the target driving voltages VRx, VGx, and VBx by calculating an interpolation of the luminance Lx and the luminance Li.

The step S104 comprises: the display driving module receiving and outputting the target driving voltages VRx, VGx, and VBx, and fine-tuning on the basis of target driving voltages VRx, VGx, and VBx for making the display module comply with the target chromaticity coordinate and the gamma curve.

The automatic adjusting method can be implemented as follows. First, the optical measuring module measures the maximum illuminates of each color in RGB color mode LRm, LGm, and LBm, and measures the chromaticity coordinate (xr,yr), (xg,yg), and (xb,yb) which represent to LRm, LGm, and LBm respectively. The chromaticity coordinate (xr,yr), (xg,yg), and (xb,yb) are steady, and will not vary with the driving voltages. Therefore, according to the maximum illuminance Lmax and coordinates of a target white point (xt,yt) inputted by a user, the target illuminances in Lmax of RGB color LRt, LGt, and LBt can be obtained.

The relations between the illuminances and chromaticity are as follows.

$$\begin{matrix}\{ \begin{matrix}\frac{{L}_{Gt}}{{L}_{Rt}} = ( \frac{{y}_{g}}{{y}_{r}} ) ( \frac{( {x}_{r} - {x}_{t} ) ( {y}_{b} - {y}_{t} ) - ( {x}_{b} - {x}_{t} ) ( {y}_{r} - {y}_{t} )}{( {x}_{b} - {x}_{t} ) ( {y}_{g} - {y}_{t} ) - ( {x}_{g} - {x}_{t} ) ( {y}_{b} - {y}_{t} )} ) \\ \frac{{L}_{Bt}}{{L}_{Rt}} = ( \frac{{y}_{b}}{{y}_{r}} ) ( \frac{( {x}_{r} - {x}_{t} ) ( {y}_{g} - {y}_{t} ) - ( {x}_{g} - {x}_{t} ) ( {y}_{r} - {y}_{t} )}{( {x}_{g} - {x}_{t} ) ( {y}_{b} - {y}_{t} ) - ( {x}_{b} - {x}_{t} ) ( {y}_{g} - {y}_{t} )} )\end{matrix} & ( 1 ) \\ L max = ( 1 + \frac{{L}_{Gt}}{{L}_{Rt}} + \frac{{L}_{Bt}}{{L}_{Rt}} ) \cdot {L}_{Rt} & ( 2 )\end{matrix}$$

From formulas (1) and (2), the target illuminances of RGB color LRt, LGt, and LBt can be obtained. However, if LRm, LGm, and LBm satisfy one of the conditions in the following formula (3), it means the display device cannot satisfy the requirements from users.

$$\{ \begin{matrix}{L}_{Rm} < {L}_{Rt} \\ {L}_{Gm} < {L}_{Gt} \\ {L}_{Bm} < {L}_{Bt}\end{matrix} \qquad ( 3 )$$

If the formula (3) cannot be satisfied, then the white balance can be adjusted. Let m=LGt/LRt and n=LBt/LRt. The output control unit makes the display driving module output a group of driving voltages VR′, VG′, and VB′. Therefore, the illuminances and chromaticity coordinate of the display devices become L′ and (x′, y′). Illuminances of each RGB color in L′ can be obtained from the formula (1) above.

$$\{ \begin{matrix}{m}^{′} = \frac{{{L}_{G}}^{′}}{{{L}_{R}}^{′}} = ( \frac{{y}_{g}}{{y}_{r}} ) ( \frac{( {x}_{r} - {x}^{′} ) ( {y}_{b} - {y}^{′} ) - ( {x}_{b} - {x}^{′} ) ( {y}_{r} - {y}^{′} )}{( {x}_{b} - {x}^{′} ) ( {y}_{g} - {y}^{′} ) - ( {x}_{g} - {x}^{′} ) ( {y}_{b} - {y}^{′} )} ) \\ {n}^{′} = \frac{{{L}_{B}}^{′}}{{{L}_{R}}^{′}} = ( \frac{{y}_{b}}{{y}_{r}} ) ( \frac{( {x}_{r} - {x}^{′} ) ( {y}_{g} - {y}^{′} ) - ( {x}_{g} - {x}^{′} ) ( {y}_{r} - {y}^{′} )}{( {x}_{g} - {x}^{′} ) ( {y}_{b} - {y}^{′} ) - ( {x}_{b} - {x}^{′} ) ( {y}_{g} - {y}^{′} )} )\end{matrix} \qquad ( 4 )$$

If m′<m, then VG′ will be raised to increase the ratio of green color. If m′>m VG′ will be decreased. If n′<n, VB′ will be raised to increase the ratio of blue color. If n′>n, VB will be decreased. When m′=m and n′=n, or the differences fall in a tolerance scope, it means that the white chromaticity coordinate satisfy the target chroma. The driving voltages of RGB colors are VB, VG, and VB at this moment.

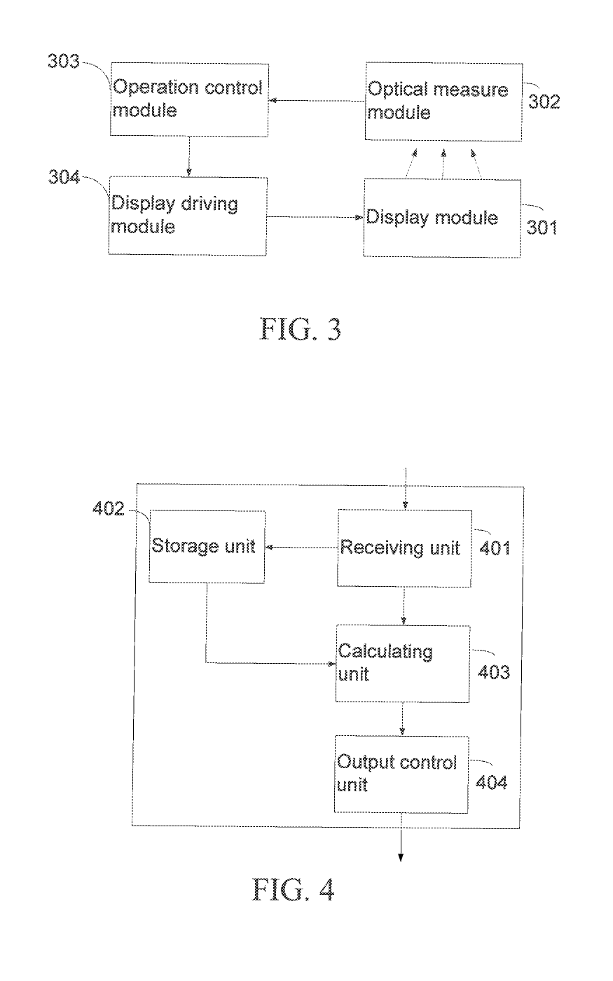

A conventional OLED pixel circuit which uses a 2T1C (two transistors and one capacitor) structure is shown in FIG. 4. The current passing through the OLED is:

I_{OLED}=k(V_{GS}−Vₜₕ)² (5).

Where VGS represents the voltage difference between gate and source, Vth represents a threshold voltage of T2, and k is a parameter relating to carrier mobility, structure, and channel capacitance of T2. Various compensating circuits developed in recent years can eliminate the influence over OLEDs resulting from Vth. The present disclosure focuses on a pixel circuit which can compensate Vth. The formula (5) can be simplified as:

I_{OLED}=k(V_{data}−VDD)² (6).

When a current is passing through an OLED, illuminance is generated by the current and the current is approximately a direct ratio which is:

L_{OLED}∝e·I_{OLED} (7)

Where e represents the illuminating efficiency of the OLED. The illuminating efficiency of a single-color OLED is constant. Therefore:

L_{OLED}∝ek(V_{data}−VDD)² (8)

The chromaticity will remain the same when the coordinates remain the same. Thus the ratio of illuminances of RGB colors will remain the same as well. The ratio will be:

L_{R255}:L_{G255}:L_{B255}=L_{R128}:L_{G128}:L_{B128} (9)

The relations of the driving voltages between RGB colors are:

(V_{R255}−VDD):(V_{G255}−VDD):(V_{B255}−VDD)=(V_{R128}−VDD):(V_{G128}−VDD):(V_{B128}−VDD) (10)

Therefore, when the chromaticity coordinate remain the same, the ratio of the driving voltages between RGB colors will remain the same as well. This law can be utilized to obtain driving voltages of RGB colors for white screens in different illuminances. Take the VR, VG, and VB obtained above for example. VB can be changed into any voltage VBi which falls in the scope that the display driving module allows. Because p=(VR−VDD)/(VB−VDD) and q=(VG−VDD)/(VB−VDD), therefore VRi and VGi will be obtained easily according to p and q. The illuminance Li and driving voltages VRi, VGi, and VBi will be stored in the storage unit.

According to the maximum illuminance Lmax and gamma exponent γ, an illuminance Lx of any grayscale Gx can be computed by measuring and comparing with a minimum illuminance Lmin:

$$\frac{L x - L min}{L max - L min} = {( \frac{G x}{{2}^{″} - 1} )}^{γ} \qquad ( 11 )$$

Where n is an integer more than zero. 0<Gx<2n−1. Preferably, 2n−1 is 28−1.

The driving voltages VRx, VGx, and VBx can be obtained by calculating linear interpolations of Lx and Li. For example, if L(i−1)≤Lx<Li, then.

$$\frac{{V}_{Rx} - {V}_{R ( i - 1 )}}{{V}_{Ri} - {V}_{R ( i - 1 )}} = \frac{{V}_{Gx} - {V}_{G ( i - 1 )}}{{V}_{Gi} - {V}_{G ( i - 1 )}} = \frac{{V}_{Bx} - {V}_{B ( i - 1 )}}{{V}_{Bi} - {V}_{B ( i - 1 )}} = \frac{{L}_{x} - {L}_{( i - 1 )}}{{L}_{i} - {L}_{( i - 1 )}} \qquad ( 12 )$$

Because the ratios between the illuminances and the driving voltages are not linear and relative factors are complex, the target driving voltages can only be obtained from linear interpolations. Then the user's requirements of white chromaticity and gamma curve may be satisfied by fine-tuning. A non-linear interpolation may be applied:

$$( \begin{matrix}{\frac{{V}_{Rx} - {V}_{R ( i - 1 )}}{{V}_{Ri} - {V}_{R ( i - 1 )}} )}^{α} = {( \frac{{V}_{Gx} - {V}_{G ( i - 1 )}}{{V}_{Gi} - {V}_{G ( i - 1 )}} )}^{α} = {( \frac{{V}_{Bx} - {V}_{B ( i - 1 )}}{{V}_{Bi} - {V}_{B ( i - 1 )}} )}^{α} = \frac{{L}_{x} - {L}_{( i - 1 )}}{{L}_{i} - {L}_{( i - 1 )}} & ( 13 )\end{matrix}$$

Where α can be greater than or equal to 2.

The fine-tuning can be implemented by adjusting the driving voltages of RGB colors respectively according to the measured values and target values of illuminances obtained by formula (1) and (2).

The present disclosure further provides an automatic adjusting system of luminance and brightness for an active matrix organic light emitting diode (AMOLED) display device as shown in FIG. 3. The system comprises: a display module 301 configured to display, an optical measuring module 302 configured to optically measure the display module and configured to transmit the measured luminances and chromaticity coordinate to an operation control module 303. The operation control module 303 is configured to calculate target luminances and target chromaticity coordinate of each grayscale, and is configured to calculate target driving voltages making the display module 301 comply with the target luminance and the target chromaticity coordinate. The display driving module 304 is configured to convert register values into driving voltages and transmit the driving voltages to the display module 301.

The structure of the operation control module 303 is shown in FIG. 4. It comprises a receiving unit 401, a storage unit 402, a calculating unit 403 and a output control unit 404. The receiving unit 401 is configured to receive luminances and chromaticity coordinate measured by the optical measuring module. The storage unit 402 is configured to storage the data measured presently, and storage luminances of the display deceive when different driving voltages applied. The calculating unit 403 is configured to obtain the target luminances of grayscales according to a maximum luminance Lmax and a gamma curve required by users. The calculating unit 403 is also configured to adjust the present driving voltages for making the chromaticity coordinates of the display module comply with the target chromaticity coordinates, i.e., the coordinate of a white point (Xwt, Ywt). The calculating unit 403 is also configured to calculate the target driving voltages for making the luminance of the display module comply with the target luminances. The output control unit 404 is configured to control grayscale of the display device, and configured to output a register value correspond to the target driving voltages. The system adjust white balance when one of the luminances of red, green, or blue images measured by the optical measuring module is greater than or equal to the target luminances.

In comparison with present adjusting method of luminance and brightness for AMOLED display devices, the present disclosure provides an automatic adjusting method of luminance and brightness for AMOLED display devices which does not require establishing a look up table of single color image regarding driving voltages, thus the influence resulting from various factors of manufacture may be reduced. By utilizing the emitting mechanism and characteristics of OLEDs, the operations for white balance and adjusting of gamma become more precise and efficient by rapidly approaching the driving voltages to target levels. Meanwhile, the computing load will decline. Therefore the automatic adjusting speed of luminance and brightness can be accelerated. As a result, the manufacturing capacity of OLED display device can increase because time spent on adjusting and testing decreases.

In conclusion, although this disclosure has been disclosed through the preferable embodiments above, the preferable embodiments above are not utilized to limit this disclosure. One having ordinary skills can change and modify without violating the concepts and scope of this disclosure. Therefore, the scope that this disclosure protects is based on the scope defined by the claims.

1. An automatic adjusting method of luminance and brightness for an active matrix organic light emitting diode (AMOLED) display device, comprising:
step S101: measuring, with an optical measuring module, a maximum luminance LRm of a red image, a maximum luminance LGm of a green image, and a maximum luminance LBm of a blue image displayed by a display module of the AMOLED display device, and obtaining chromaticity coordinates corresponding to the maximum luminance LRm, maximum luminance LGm, and maximum luminance LBm;
step S102: transmitting the maximum luminance LRm, maximum luminance LGm, maximum luminance LBm, and the chromaticity coordinates corresponding to the maximum luminance LRm, maximum luminance LGm, and maximum luminance LBm from the optical measuring module to an operation control module;
step S103: calculating, with the operation control module, target luminances of grayscales according to the maximum luminance LRm, maximum luminance LGm, maximum luminance LBm, and a gamma curve, adjusting driving voltages corresponding to a target chromaticity coordinate, and calculating target driving voltages for making luminance of the display module comply with the target luminances of the grayscales, where the operation control module controls the grayscales of the display module, and outputs register values corresponding to the target driving voltages, wherein the target chromaticity coordinate is the chromaticity coordinate corresponding to the maximum luminance LRm, maximum luminance LGm, and maximum luminance LBm;
step S104: controlling, with the operation control module, a display driving module of the AMOLED display device to transmit the target driving voltages to the display module for automatically adjusting current driving voltages.

2. The automatic adjusting method according to claim 1, wherein the step S103 comprises:
Step S1031: obtaining chromaticity driving voltages making the display modules comply with the target chromaticity coordinate;
Step S1032: making the display module illuminate white light by utilizing the chromaticity driving voltages;
step S1033: referencing a minimum luminance to obtain a first luminance corresponding to a group of driving voltages VRi, RGi, and VBi;
step S1034, calculating a second luminance of one of the grayscale corresponding to the maximum luminance LRm, maximum luminance LGm, maximum luminance LBm, and a gamma curve;
step S1035, obtaining the target driving voltages by calculating a interpolation of the first luminance and the second luminance, wherein the target driving voltages comprise VRx, VGx, and VBx corresponding red image, green image, and blue image respectively.

3. The automatic adjusting method according to claim 2, wherein the target driving voltages matches a formula for making the ratio of VRx, VGx, and VBx remain the same, wherein the formula is:
(V_{R255}−VDD):(V_{G255}−VDD):(V_{B255}−VDD)=(V_{R128}−VDD):(V_{G128}−VDD):(V_{B128}−VDD).

4. The automatic adjusting method according to claim 2, wherein the step S104 comprises: outputting the target driving voltages comprising VRx, VGx, and VBx from the display driving module, and fine-tuning the target driving voltages for making the display module comply with the target chromaticity coordinate and the gamma curve.

5. An automatic adjusting system of luminance and brightness for an active matrix organic light emitting diode (AMOLED) display device comprising:
a display module configured to display;
an optical measuring module configured to optically measure the display module;
an operation control module configured to calculate target luminances and target chromaticity coordinate of grayscales, and calculate target driving voltages making the display module comply with the target luminance and the target chromaticity coordinate;
a display driving module configured to output the target driving voltages to the display module;
wherein the operation control module comprises
a calculating unit configured to obtain the target luminances of grayscales according to a maximum luminance of the display module and a gamma curve, and configured to calculate the target driving voltages making luminances of the display module comply with the target luminances; and
a receiving unit configured to receive luminances and chromaticity coordinate measured by the optical measuring module.

6. The automatic adjusting system according to claim 5, wherein the operation control module and the display driving module are configured to adjust white balance when one of the luminances of red, green, or blue measured by the optical measuring module is greater than or equal to the target luminance.

7. The automatic adjusting system according to claim 5, wherein the operation control module comprises a storage unit configured to store a present luminance and luminances regarding various groups of driving voltages.

8. The automatic adjusting system according to claim 5, wherein the operation control module comprises a output control unit configured to control grayscale of the display device, and configured to output a register value correspond to the target driving voltages.

9. An automatic adjusting method of luminance and brightness for an active matrix organic light emitting diode (AMOLED) display device comprising:
step S101: measuring, with an optical measuring module, a maximum luminance LRm of a red image, a maximum luminance LGm of a green image, and a maximum luminance LBm of a blue image displayed by a display module of the AMOLED display device, and obtaining chromaticity coordinate corresponding to the maximum luminance LRm, maximum luminance LGm, and maximum luminance LBm;
step S102: transmitting the maximum luminance LRm, maximum luminance LGm, maximum luminance LBm, and the chromaticity coordinate corresponding to the maximum luminance LRm, maximum luminance LGm, and maximum luminance LBm from the optical measuring module to an operation control module;
step S103: calculating, with the operation control module, target luminances of grayscales according to the maximum luminance LRm, maximum luminance LGm, maximum luminance LBm, and a gamma curve, adjusting driving voltages corresponding to a target chromaticity coordinate, and calculating target driving voltages for making luminance of the display module complying with the target luminances of the grayscales, wherein the target chromaticity coordinate is the chromaticity coordinate corresponding to the maximum luminance LRm, maximum luminance LGm, and maximum luminance LBm;
step S104: controlling, with the operation control module, a display driving module of the AMOLED display device to transmit the target driving voltages to the display module for automatically adjusting current driving voltages.

10. The automatic adjusting method according to claim 9, wherein the step S103 comprises:
Step S1031: obtaining chromaticity driving voltages making the display modules comply with the target chromaticity coordinate;
Step S1032: making the display module illuminate white light by utilizing the chromaticity driving voltages;
step S1033: referencing a minimum luminance to obtain a first luminance corresponding to a group of driving voltages VRi, RGi, and VBi;
step S1034, calculating a second luminance of one of the grayscale corresponding to the maximum luminance LRm, maximum luminance LGm, maximum luminance LBm, and a gamma curve;
step S1035, obtaining the target driving voltages by calculating a interpolation of the first luminance and the second luminance, wherein the target driving voltages comprise VRx, VGx, and VBx corresponding red image, green image, and blue image respectively.

11. The automatic adjusting method according to claim 10, wherein the target driving voltages matches a formula for making the ratio of VRx, VGx, and VBx remain the same, wherein the formula is:
(V_{R255}−VDD):(V_{G255}−VDD):(V_{B255}−VDD)=(V_{R128}−VDD):(V_{G128}−VDD):(V_{B128}−VDD).

12. The automatic adjusting method according to claim 10, wherein the step S104 comprises: outputting the target driving voltages comprising VRx, VGx, and VBx from the display driving module, and fine-tuning the target driving voltages for making the display module comply with the target chromaticity coordinate and the gamma curve.
